(19) United States
(12) Patent Application Publication
(10) Pub. No.: US 2009/0201453 A1
(43) Pub. Date: Aug. 13, 2009

(54) LIQUID CRYSTAL DISPLAY PANEL AND METHOD OF MANUFACTURING THE SAME

(76) Inventors: Masaki Obi, Ageo-shi (JP); Yuuzo Hisatake, Fukaya-shi (JP); Hideki Ito, Kumagaya-shi (JP); Yasushi Kawata, Ageo-shi (JP); Akio Murayama, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/270,084

(22) Filed: Nov. 13, 2008

(30) Foreign Application Priority Data
Feb. 7, 2008 (JP) 2008-027808

(51) Int. Cl. G02F 1/1337; G02F 1/13

(52) U.S. Cl. 349/128; 430/20

(57) ABSTRACT

There is disclosed a liquid crystal display panel includes a first substrate, a second substrate arranged opposite to the first substrate with a gap, a liquid crystal layer held between the first and second substrates, and a plurality of pixels formed of the first substrate, the second substrate and the liquid crystal layer, and arrayed in a direction along a plane of the first and second substrates, each pixel having a plurality of pretilt angles different from each other.

### CROSS-REFERENCE TO RELATED APPLICATIONS

This application is based upon and claims the benefit of priority from prior Japanese Patent Application No. 2008-027808, filed Feb. 7, 2008, the entire contents of which are incorporated herein by reference.

### BACKGROUND OF THE INVENTION

1. Field of the Invention

The present invention relates to a liquid crystal display panel, and to a method of manufacturing the same.

2. Description of the Related Art

In general, a liquid crystal display device including a liquid crystal display panel has the features of light, thin, and low power consumption. Thus, the liquid crystal display device is applied to various fields such as office automation (OA) apparatuses, information terminals, watches and television receivers. In particular, the liquid crystal display panel is provided with a thin film transistor as a switching element, and thereby, a high-speed response is obtained. Therefore, the liquid crystal display device is used as a display unit of an electronic apparatus displaying a large amount of information, such as a portable television receiver or computer.

As a result of the ever-increasing amounts of information handled, it is requested to perform further high definition, high-speed response and wide viewing angle. A high definition image is realized by micro-fabricating the structure of an array substrate formed with the thin film transistor.

In order to obtain a high display speed, it has been studied to employ the following mode in place of the conventional display mode. One is an optically compensated birefringence (OCB) mode using a nematic liquid crystal. Another is a vertically aligned (VA) mode. Another is a hybrid aligned nematic (HAN) mode. Another is π alignment mode. Another is a surface stabilized ferroelectric liquid crystal mode using a smectic liquid crystal. Another is an antiferroelectric liquid crystal (AFLC) mode.

In order to achieve a wide viewing angle, it has been studied to employ an in-plane switching (IPS) mode in addition to the foregoing OCB mode and VA mode. Of such display modes, according to the VA mode, it is possible to obtain a response speed faster than the conventional twisted nematic (TN) mode. In addition, a viewing angle compensation design is relatively easy; therefore, a wide viewing angle is realizable. The VA mode employs a vertical alignment treatment, and has no need to carry out a rubbing treatment generating a failure such as electrostatic breakdown. Therefore, the foregoing VA mode has attracted much interest. For example, Jpn. Pat. Appln. KOKAI Publication No. H11-242225 has made the following proposal. Namely, a multi-domain VA mode (MVA mode) using a vertical alignment has been proposed.

For example, Jpn. Pat. Appln. KOKAI Publications No. 2003-307720 and 2006-91545 disclose the following technique. According to the technique, a polymer sustained alignment (PSA) layer is formed of a hardened polymeric compound. In order to form the PSA layer, a polymeric monomer mixed in a crystal liquid is injected into a cell, and thereafter, exposed while a voltage is applied to a liquid crystal layer to polymerize it. The PSA layer give a pretilt angle to the liquid crystal. In this way, the pretilt angle given to the periphery only of a ridge-like projection of a liquid crystal display panel is given to the whole of each pixel. Thus, this serves to improve a response speed at an intermediate portion between the projection and the peripheral edge of a pixel electrode. The response speed is improved, and thereby, light transmittance is improved. As a result, a brighter image is displayable.

As described above, the liquid crystal display panel has many advantages; however, but still has a problem that must be overcome. Specifically, when the liquid crystal display panel is viewed obliquely, luminance becomes high in intermediate gradations compared with when it is seen from the front direction. In other words, there is a possibility that a so-called “non-uniformity luminance” phenomenon occurs. In order to improve the non-uniformity luminance, the following techniques are proposed. Specifically, a pixel is divided into portions, and then, the divided pixel is independently driven. Further, a dielectric layer is formed under a pixel electrode to change an effective potential, and thereby, a plurality of pretilt angles is given into one pixel. The foregoing technique is called a half-tone gray scale method, and is disclosed in Jpn. Pat. Aplln. KOKAI Publication No. H5-66412.

However, the foregoing techniques is applicable to only the case where a pixel area is larger. Then, there is a problem concerning luminance reduction, reliability and high cost.

### BRIEF SUMMARY OF THE INVENTION

The invention has been made in view of the foregoing circumstances. An object of the invention is to provide a liquid crystal display panel, which is excellent in display quality, and to provide a method of manufacturing the same.

To achieve the object, according to an aspect of the present invention, there is provided a liquid crystal display panel comprising:

a first substrate;

a second substrate arranged opposite to the first substrate with a gap;

a liquid crystal layer held between the first and second substrates; and

a plurality of pixels formed of the first substrate, the second substrate and the liquid crystal layer, and arrayed in a direction along a plane of the first and second substrates,

each pixel having a plurality of pretilt angles different from each other.

According to another aspect of the present invention, there is provided a method of manufacturing the liquid crystal display panel comprising:

preparing a liquid crystal panel including a first substrate, a second substrate arranged opposite to the first substrate with a gap, a liquid crystal layer held between the first and second substrates and formed of a liquid crystal composition containing a polymer compound and a plurality of pixels formed of the first substrate, the second substrate and the liquid crystal layer, and arrayed in a direction along a plane of the first and second substrates; and

irradiating light to the liquid crystal layer via a photo mask in a state that voltage is applied to the liquid crystal layer of the liquid crystal panel to harden the polymer compound, and giving a plurality of pretilt angles different from each other to each pixel.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a liquid crystal display panel according to an embodiment of the present invention;

FIG. 2 is a cross-sectional view showing a part of the liquid crystal display panel shown in FIG. 1;

FIG. 3 is a block diagram schematically showing the configuration of a part of an array substrate shown in FIG. 1 and FIG. 2;

FIG. 4 is another cross-sectional view showing a part of the foregoing liquid crystal display panel;

FIG. 5 is a top plan view schematically showing the wiring structure of the foregoing liquid crystal display panel, and in particular, a schematic view showing an aligned state of a liquid crystal molecule of first and second pretilt areas when a voltage is applied to a liquid crystal layer of a liquid crystal display panel according to an example 1;

FIG. 6 is a cross-sectional view showing a liquid crystal display panel taken along the line VI-VI of FIG. 5;

FIG. 7 is a cross-sectional view showing a liquid crystal display panel taken along the line VII-VII of FIG. 5;

FIG. 8 is a cross-sectional view showing a liquid crystal display panel taken along the line VIII-VIII of FIG. 5;

FIG. 9 is an enlarged cross-sectional view showing a part of the foregoing liquid crystal display panel, and in particular, a schematic view showing an aligned state of a liquid crystal molecule of a first pretilt areas when a voltage is not applied to a liquid crystal layer;

FIG. 10 is an enlarged cross-sectional view showing a part of the foregoing liquid crystal display panel, and in particular, a schematic view showing an aligned state of a liquid crystal molecule of a second pretilt areas when a voltage is not applied to a liquid crystal layer;

FIG. 11 is a graph showing a change in luminance with respect to the voltage applied to a liquid crystal layer of first and second pretilt areas;

FIG. 12 is a top plan view showing the wiring structure of a liquid crystal display panel of an example 2 according to the embodiment of the present invention, and in particular, a schematic view showing the first and second pretilt areas;

FIG. 13 is a table showing a contrast ratio, a response speed and white dot in examples 1 and 2 according to the embodiment of the present invention, comparison examples 1 and 2; and

FIG. 14 is a graph showing a change in relative luminance with respect to gradations in a front direction (0°) and oblique direction (30°, 60°) of a liquid crystal display panel according to the comparison example 2.

### DETAILED DESCRIPTION OF THE INVENTION

A liquid crystal display panel and a method of manufacturing the same will be hereinafter described with reference to the accompanying drawings.

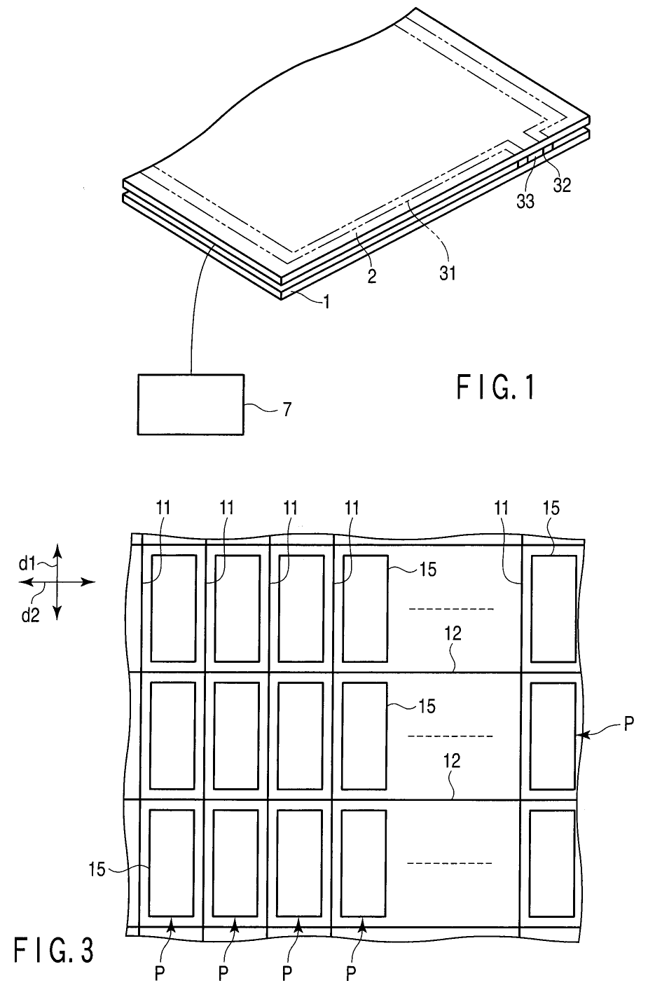

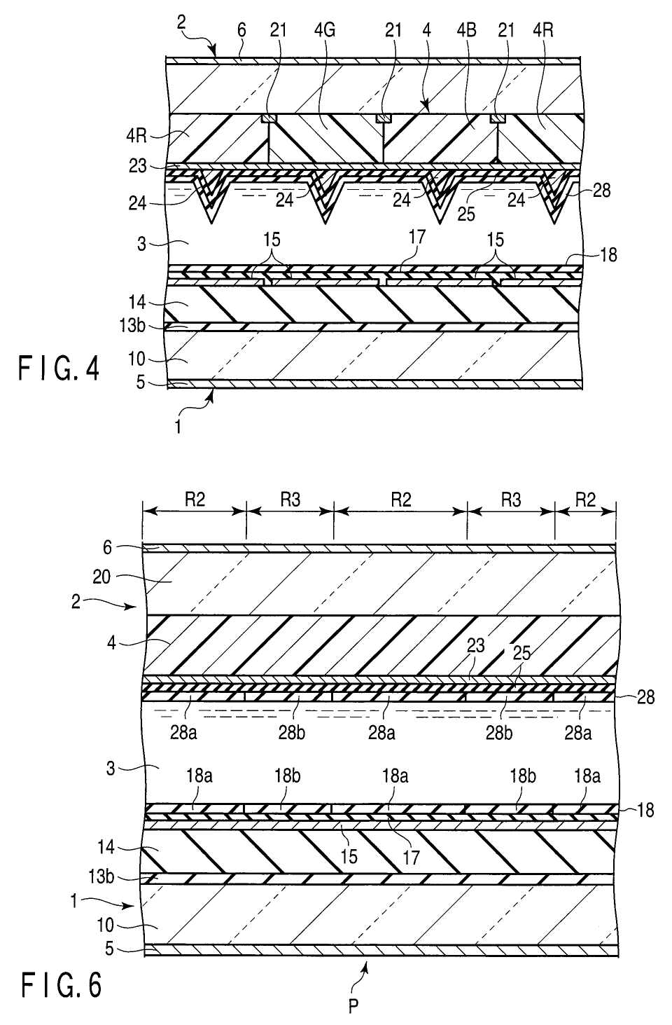

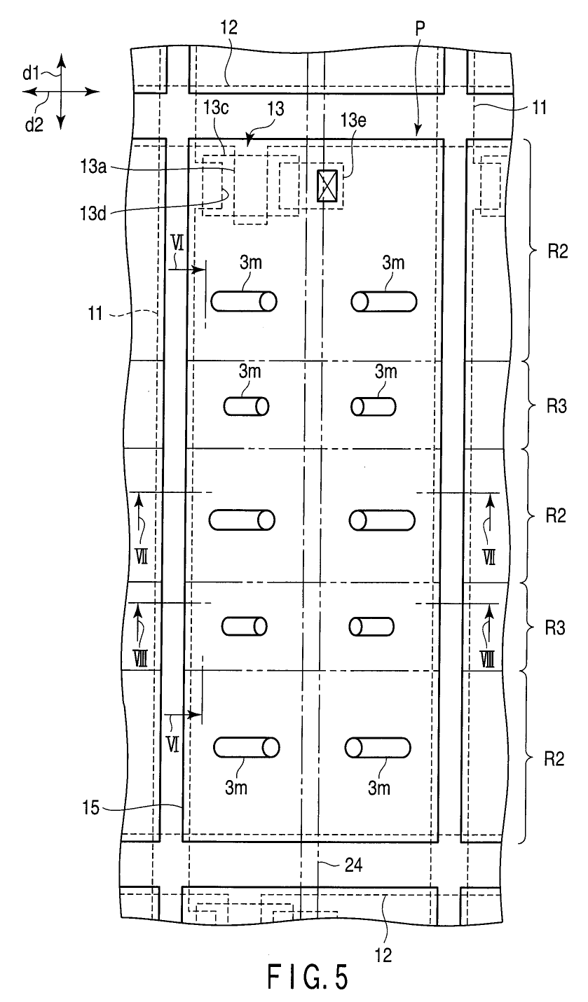

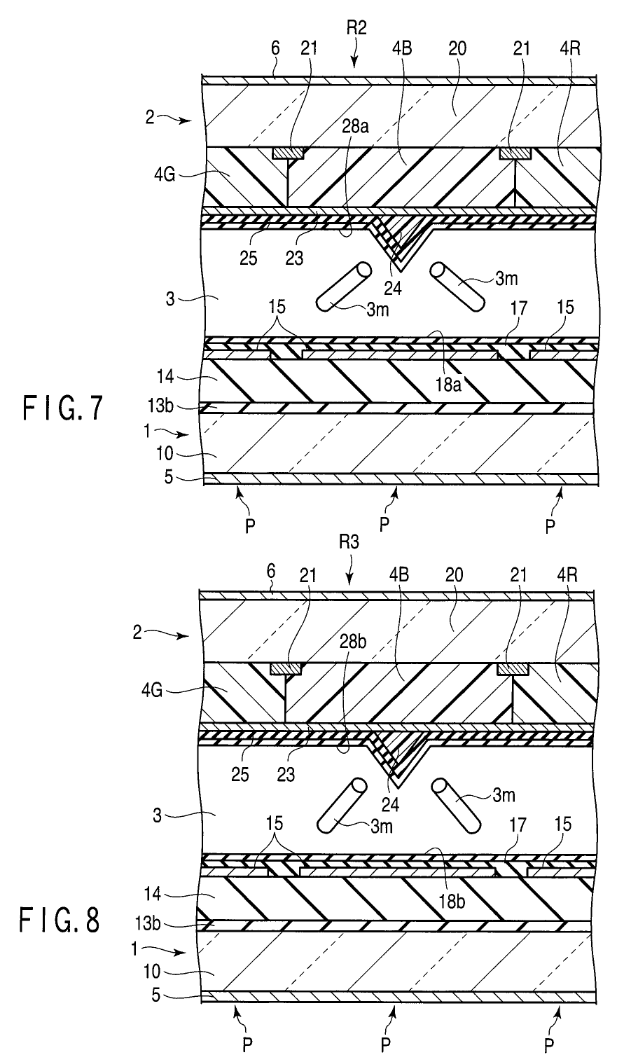

As shown in FIG. 1 to FIG. 8, a liquid crystal display panel comprises an array substrate 1, a counter substrate 2, a liquid crystal layer 3, a color filter 4, first and second polarizers 5 and 6. Specifically, the array substrate 1 is used as a first substrate. The counter substrate 2 is used as a second substrate. The counter substrate 2 is arranged opposite to the array substrate with a predetermined gap therebetween. The liquid crystal layer 3 is held between the array substrate and counter substrate. The liquid crystal display panel is connected with a controller 7, and these form a liquid crystal display device together with a backlight unit. The display, comprised of the liquid crystal display panel, is of the MVA mode. The liquid crystal display panel includes a rectangular display area R1.

The array substrate 1 has a rectangular glass substrate 10 as a transparent insulation substrate. The counter substrate 2 has a rectangular glass substrate 20 as a transparent insulation substrate. In the display area R1, the liquid crystal display panel includes a plurality of pixels P. One of the pixels P is formed of the array substrate 1, the counter substrate 2 and the liquid crystal layer 3, and arranged in a direction along the plane surface of the array and counter substrates. The pixels P are arranged in a matrix between the glass substrates 10 and 20. The pixels P are arrayed in first direction d1 and second direction d2, perpendicular to each other. Each pixel P has major axis in the first direction d1.

In the array substrate 1, a plurality of signal lines 11 and a plurality of scanning lines 12 are arranged in a lattice on the glass substrate. The signal lines 11 extend in the first direction d1, and are arranged at intervals in the second direction d2. The scanning lines 12 extend in the second direction d2, and are arranged at intervals in the first direction d1. Each pixel P is arrayed to overlap with an area surrounded by two neighboring signal lines 11 and two neighboring scanning lines 12.

For example, a plurality of thin film transistors (TFT) 13 are provided as plural switching elements in the vicinity of the crossing portion of the signal and scanning lines 11 and 12 on the glass substrate 10. The TFT 13 has a gate electrode 13a, a gate insulating film 13b, a channel layer 13c, a source electrode 13d and a drain electrode 13e. Specifically, the gate electrode 13a is formed by extending a part of the scanning line 12. The gate insulating film 13b is formed on the gate electrode 13a. The channel layer 13c faces the gate electrode via the gate insulating film. The source electrode 13d is connected to one area of the channel layer. The drain electrode 13e is connected to the other area of the channel layer.

The source electrode 13d is connected to the signal line 11, and the drain electrode 13e is connected to a pixel electrode 15 described later. The TFT 13 is formed of a common gate insulating film 13b. The TFT 13 is provided for each pixel P, which thus forms a pixel.

An interlayer insulating film 14 is formed on the glass substrate 10, signal line 11, scanning line 12 and TFT 13. In the display area R1, a plurality of pixel electrodes 15 are arranged in a matrix on the interlayer insulating film 14. The pixel electrode 15 is formed of a transparent conductive material such as indium tin oxide (ITO). Each pixel electrode 15 is electrically connected with the drain electrode 13e of the corresponding TFT 13 via a contact hole formed in the interlayer insulating film 14. The pixel electrode 15 is provided for each pixel P, which thus forms a pixel.

A plurality of pillar spacers 16 are formed on the pixel electrode 15 as a spacer. The spacer is not limited to the pillar spacer 16; in this case, other spacers such as a spherical spacer may be used. An alignment film 17 is formed on the interlayer insulating film 14 and the pixel electrode 15. According to this embodiment, the alignment film 17 is a vertical alignment film.

A polymer sustained alignment (PSA) layer 18 is formed on the alignment film 17 as a liquid crystal molecule alignment maintaining layer. The PSA layer 18 is overlapped with a plurality of pixels P, and formed on the entire area overlapping the liquid crystal layer 3. The PSA layer 18 contacts the liquid crystal layer 3.

In the counter substrate 2, the glass substrate 20 is provided with a lattice-like first shield portion 21 and a rectangular frame-shaped second shield portion 22. The first shield portion 21 is formed to surround the pixels P. The second shield portion 22 is formed to surround the display area R1. The first and second shield portions 21 and 22 function as a black matrix.

The glass substrate 20 is provided with a color filter 4. The color filter 4 has a red colored layer 4R, a green colored layer 4G and a blue colored layer 4B. The colored layers 4R, 4G and 4B extend in the first direction d1 and in strips. The colored layers 4R, 4G and 4B are alternately arranged adjacent to one another in the second direction d2.

The color filter 4 is formed with a common electrode 23 formed of a transparent conductive material such as ITO. The common electrode 23 is formed with a plurality of projections 24. The projection 24 projects from the surface of the common electrode 23 to the side of the array substrate 1. The projection 24 is formed in a strip, and a convex portion having a triangular section is extended to the first direction d1. In other words, the projection 24 extends in a direction along the major axis of the pixel P. The projections 24 are arranged, with a certain interval between them, in the second direction d2.

Each projection 24 is overlapped with a plurality of pixels P, and positioned to divide the pixel P to two equal portions in the second direction d2. According to this embodiment, the plurality of projections 24 act as an alignment controller. These projections 24 have a function of controlling the alignment direction of the liquid crystal molecules 3m in the facing liquid crystal layer 3. The foregoing function is performed when a voltage is applied between the pixel electrode 15 and the common electrode 23.

An alignment film 25 is deposited on the common electrode 23 and the projection 24. According to this embodiment, the alignment film 25 is a vertical alignment film. In a state that no voltage is applied between the pixel electrode 15 and the common electrode 23, the alignment film 25 aligns the liquid crystal molecules 3m in a direction vertical to the foregoing surface together with the alignment film 17.

A PSA layer 28 is formed on the alignment film 25 as another liquid crystal molecule alignment maintaining layer. The PSA layer 28 overlaps the pixels P, and is formed over the entire area overlapping the liquid crystal layer 3. The PSA layer 28 contacts the liquid crystal layer 3.

The array substrate 1 and the counter substrate 2 are arranged opposite to each other with a predetermined gap by the pillar spacers 16. The array substrate 1 and the counter substrate 2 are bonded to each other by a sealing member 31 provided at the peripheral edge portions of both substrates.

The liquid crystal layer is held between the array substrate 1 and the counter substrate 2. A part of the sealing member 31 is formed with a liquid crystal injection port 32. The liquid crystal injection port 32 is sealed by a sealant 33. The liquid crystal layer 3 is formed of a liquid crystal material having a negative dielectric anisotropy. The liquid crystal molecules 3m of the liquid crystal layer 3 are aligned in a direction perpendicular to each projection 24.

The first polarizer 5 is provided at an outer surface of the glass substrate 10. The second polarizer 6 is provided at an outer surface of the glass substrate 20.

The controller 7 is electrically connected to the array substrate 1 and the counter substrate 2. More specifically, the controller 7 is electrically connected to a plurality of pixel electrodes 15 and the common electrode 23. The controller 7 controls a voltage applied between a plurality of pixel electrodes 15 and the common electrode 23, and controls an alignment state of each liquid crystal molecule 3m.

As described above, an MVA mode liquid crystal display panel is formed.

The pixel P, in particular, the PSA layers 18 and 28 will be described below.

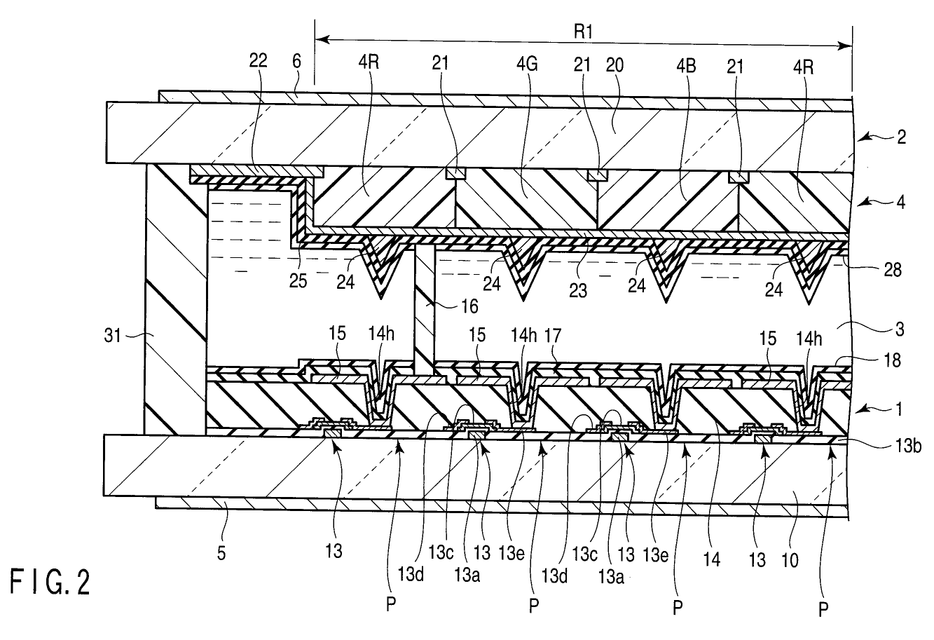

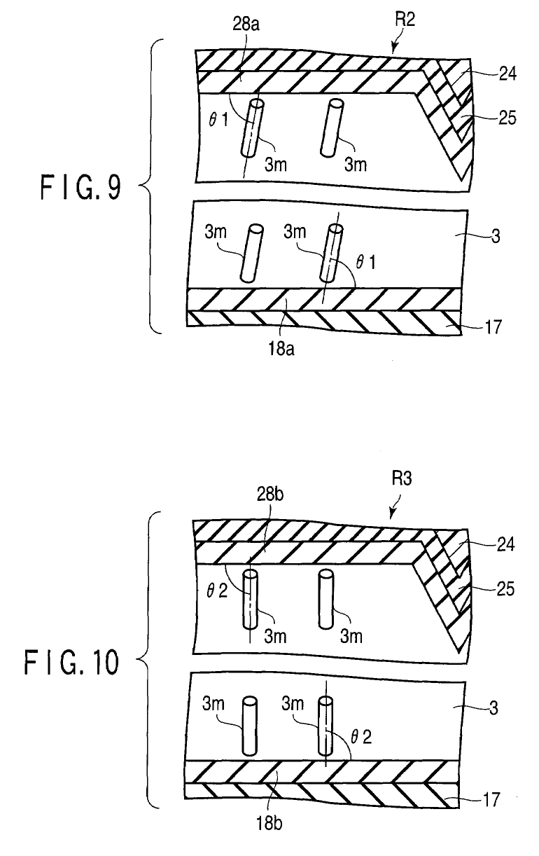

As shown FIG. 2 and FIG. 5 to FIG. 10, each pixel P has a plurality of pretilt areas arranged in a direction along the plane of the array and counter substrates 1 and 2. The PSA layers 18 and 28 give a mutually different pretilt angle to the pretilt areas of each pixel P.

According to this embodiment, each pixel P has a plurality of first pretilt areas R2 and a plurality of second pretilt areas R3. The first and second pretilt areas R2 and R3 are alternately arranged in a direction along the major axis of the pixel P.

The PSA layer 18 has a plurality of first PSA portions 18a overlapping with the first pretilt areas R2 and a plurality of second PSA portions 18b overlapping with the second pretilt areas R3. The first PSA portions 18a give a first pretilt angle θ1 to the first pretilt areas R2. The second PSA portions 18b give a second pretilt angle θ2, different from the first pretilt angle θ1, to the second pretilt areas R3. The first pretilt angle θ1 is smaller than the second pretilt angle θ2.

The PSA layer 28 has a plurality of first PSA portions 28a overlapping with the first pretilt areas R2, and a plurality of second PSA portions 28b overlapping with the second pretilt areas R3. The first PSA portions 28a give a first pretilt angle θ1 to the first pretilt areas R2. The second PSA portions 28b give a second pretilt angle θ2 to the second pretilt areas R3.

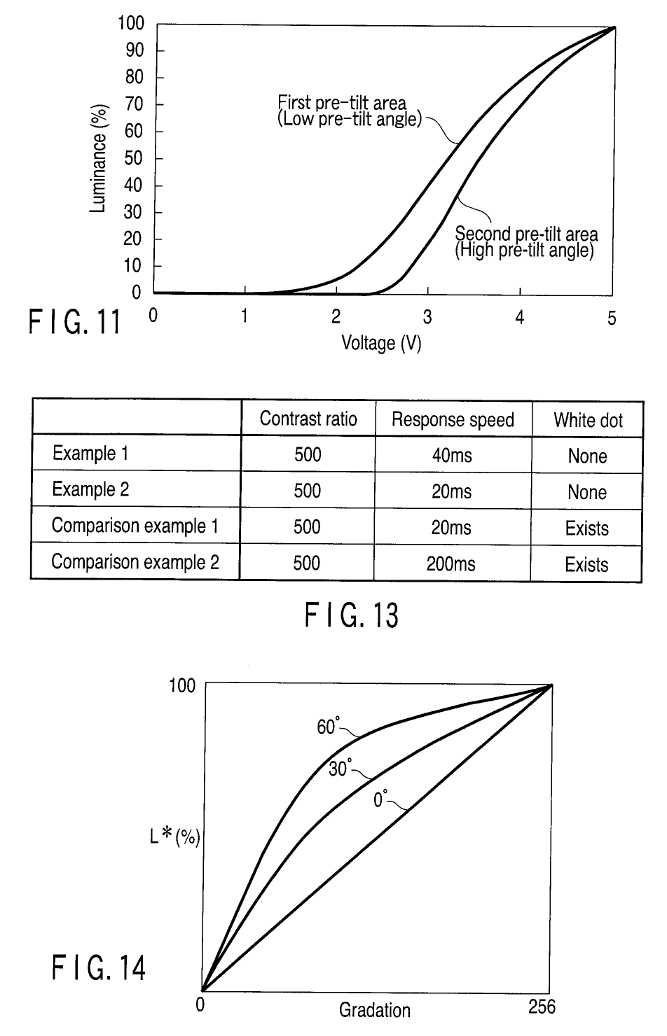

As described above, in each pixel P, the PSA layers 18 and 28 give the first pretilt angle θ1 to the first pretilt areas R2 and give the second pretilt angle θ2 to the second pretilt areas R3, respectively. The first pretilt angle θ1 is smaller than the second pretilt angle θ2. Thus, the first pretilt area R2 can obtain a faster response compared with the second pretilt area R3. (see FIG. 11)

In other words, the liquid crystal molecule 3m of the first pretilt area R2 is always more oblique than the liquid crystal molecule 3m of the first pretilt area R3 in a direction along the plane of the array and counter substrates 1 and 2. The liquid crystal molecule 3m of the first pretilt area R2 and the liquid crystal molecule 3m of the second pretilt area R3 are always oblique in mutually different directions.

Thus, white dot causing in a specified direction inclined from the front of the conventional liquid crystal display panel is dispersed to a plurality of oblique directions inclined from the liquid crystal display panel. In this way, the liquid crystal display panel can display a preferable image in an oblique direction and of course, the front direction.

A method of manufacturing the liquid crystal display panel having the foregoing structure will be hereinafter described.

As shown in FIG. 1 to FIG. 10, a glass substrate 10 is prepared. A signal line, 11, a scanning line 12 and a TFT 13 are formed via a normal manufacturing process of repeating deposition and patterning on the prepared glass substrate 10.

More specifically, molybdenum is deposited on the glass substrate 10 to have a thickness of about 0.3 μm using sputtering. The deposited molybdenum is patterned to a predetermined shape using a photolithography process. In this way, the scanning line 12 and a gate electrode 13a are formed. Thereafter, silicon dioxide and silicon nitride are deposited on the glass substrate 10, scanning line 12 and a gate electrode 13a to have a thickness of about 0.15 μm, and thereby, a gate insulating film 13b is formed.

A semiconductor film is deposited on the gate insulating film 13b, and then, the deposited semiconductor film is patterned to form a channel layer 13c. Thereafter, aluminum (Al) is deposited on the gate insulating film 13b and the channel layer 13c to have a thickness of 0.3 μm. Then, the deposited aluminum is patterned to form the signal line 11, a source electrode 13d and a drain electrode 13e. In this way, the signal line 11, the scanning line 12 and the TFT 13 are formed.

A photosensitive resist is coated on the entire surface of the gate insulating film 13b using a spinner to form an insulating film. The deposited insulating film is patterned to a predetermined shape using a photography process. In this way, an interlayer insulating film 14 formed with a plurality of contact holes 14h is formed.

Thereafter, an ITO is deposited on the interlayer insulating film 14 to have a thickness of about 0.1 μm using sputtering. Then, the deposited ITO film is patterned to form a pixel electrode 15. A transparent resin resist is coated on the interlayer insulating film 14 and the pixel electrode 15. Then, the coated transparent resin resist is patterned using a photolithography process. In this way, a plurality of pillar spacers 15 having a height of 4.0 μm are formed.

A vertical alignment material is coated on the interlayer insulating film 14 and the pixel electrode 15 to have a thickness of 70 nm to form an alignment film 17. In this way, an array substrate 1 is completed.

According to a method of manufacturing a counter substrate 2, a glass substrate 20 is first prepared. CrO^{X} and Cr are continuously deposited on the prepared glass substrate 20. The stacked film of CrO_{X} and Cr is patterned using a photolithography process. In this way, first and second shield portions 21 and 22 are formed on the glass substrate 20.

A photosensitive resist dispersing a red pigment (hereinafter, referred to as a red resist) is coated on the entire surface of the glass substrate 20. Then, the coated red resist is patterned using a photolithography process. In this way, a plurality of red colored layers 4R is formed.

Thereafter, a plurality of green and blue colored layers 4G and 4B are successively formed using a photolithography process. In this way, a color filter 4 having colored layers 4R, 4G and 4B having a thickness of 1.0 μm is formed.

Then, an ITO is deposited on the color filter 4 to have a thickness of about 0.1 μm via sputtering. In this way, a common electrode 23 is formed on the color filter 4. Thereafter, a resin resist is patterned so that a plurality of projections 24 is formed on the common electrode 23. A vertical alignment film material is coated on the glass substrate 20, color filter 4 and projections 24 to have a thickness of 70 nm, and thereby, an alignment film 25 is formed. In this way, the counter substrate 2 is completed.

Thereafter, the array substrate 1 and the counter substrate 2 are positioned using a jig. For example, a thermosetting sealing material 31 is printed on the peripheral edge portion of the glass substrate 20. In this case, the sealing material 31 is formed of an epoxy thermosetting resin. The array substrate 1 and the counter substrate 2 are arranged opposite to each other spaced apart by a predetermined gap using a plurality of pillar spacers 16. The peripheral edge portions of the array and counter substrates are bonded together using the sealing member 31. Thereafter, the sealing member 31 is heated to be hardened, and thereby, the array substrate 1 and the counter substrate 2 are fixed.

A liquid crystal composition containing a polymer compound is injected from a liquid crystal injection port 32 formed in a part of the sealing member 31 via vacuum injection. More specifically, the following material is added to the liquid crystal material having negative dielectric anisotropy. Namely, UCL-011, made by Dai Nihon Ink Company, which has a liquid crystal material ratio 2 wt %, is added as a polymerization monomer. Further, an Irgacure 651, made by ChibaGaigi company, is added as a photo initiator.

Thereafter, the liquid crystal injection port 32 is sealed using a sealant 33 formed of ultraviolet hardening resin, for example. In this way, a liquid crystal is sealed between the array substrate 1 and the counter substrate 2 so that a liquid crystal layer 3 is formed. In the foregoing manner, a liquid crystal display panel including the array substrate 1, the counter substrate 2, the liquid crystal layer 3 and a plurality of pixels P is formed.

An AC voltage of 5 V is applied between the pixel electrode 15 and the common electrode 23 of the prepared liquid crystal panel so that a voltage is applied to the liquid crystal layer 3. In this way, the liquid crystal molecule 3m is in an aligned state inclined from a normal line direction of the plane of the array and counter substrates 1 and 2. In a state that a voltage is applied to the liquid crystal layer 3, light is irradiated to the liquid crystal layer 3 from outside of the array substrate 1 via a photo mask (not shown). In this case, the used photo mask has the following pattern. Specifically, the photo mask exposes a plurality of first pretilt areas R2, and covers a plurality of second pretilt areas R3. According to the foregoing light irradiation, ultraviolet rays having a wavelength of 365 nm are irradiated to the liquid crystal layer 3 for three minutes.

By the foregoing light irradiation, photo polymerization is started, and then, a polymer compound is hardened. The hardened polymer compound forms first PSA portions 18a giving a first pretilt angle θ1 at a plurality of first pretilt areas R2 of the array substrate 1. Further, first PSA portions 28a giving a first pretilt angle θ1 are formed at a plurality of first pretilt areas R2 of the counter substrate 2.

Thereafter, application of an AC voltage of 5 V is stopped between the pixel electrode 15 and the common electrode 23 of the liquid crystal panel so that a voltage of 0 V is applied to the liquid crystal layer 3. In this way, the liquid crystal molecule 3m is in a state aligned with the normal line direction of the plane of the array substrate 1 and the counter substrate 2, except for the first pretilt area R2. In a state that no voltage is applied to the liquid crystal layer 3 (0 V), light is irradiated to the liquid crystal layer 3 from the outside of the array substrate 1 with no photo mask. In this case, according to the light irradiation, ultraviolet rays having a predetermined wavelength are irradiated to the liquid crystal layer 3 for a predetermined time.

By the foregoing light irradiation, the polymer compound, which is not hardened, is hardened. The hardened polymer compound forms second PSA portions 18b giving a second pretilt angle θ2 at a plurality of second pretilt areas R3 of the array substrate 1. Further, second PSA portions 28b giving a second pretilt angle θ2 are formed at a plurality of second pretilt areas R3 of the counter substrate 2. The second PSA portions 18b and 28b are formed at areas except for the display area R1, also. The second PSA portions 18b and 28b are formed at areas except for the first pretilt area R2. The polymer compound is hardened; therefore, a bad influence is not given to the display image.

A first polarizer 5 is arranged on the outer surface of the array substrate 1, and a second polarizer 6 is arranged at the outer surface of the counter substrate 2. In this way, a multi-domain VA mode liquid crystal display panel is completed.

### EXAMPLE 1

According to the example 1, the liquid crystal display panel is formed in the manner described above. The pixel size is 40 μm×120 μm. The width between the projections (i.e., length in the second direction d2) and the width between neighboring pixel electrodes are each 10 μm.

Inventors of this application performed a characteristic evaluation of the liquid crystal display panel according to the example 1. As seen from FIG. 13, a white dot is visibly evaluated in a direction inclined to the front of the liquid crystal display panel, that is, from an oblique viewing angle direction; as a result, a white dot was not detected. Thus, a preferable oblique viewing angle is obtained. Therefore, a preferable image is displayable in an oblique direction in the liquid crystal display panel according to the example 1.

A speed (response speed of liquid crystal), that is, a change in speed from 0% to 10% of transmittance of the liquid crystal display panel is 40 ms. Thus, in low gradation side, preferable motion image display is possible. When voltages 0 V and 5 V are applied to the liquid crystal layer 3, a luminance of the liquid crystal display panel was measured, and further, a contrast ratio was calculated. As a result, the contrast ratio was 500.

### EXAMPLE 2

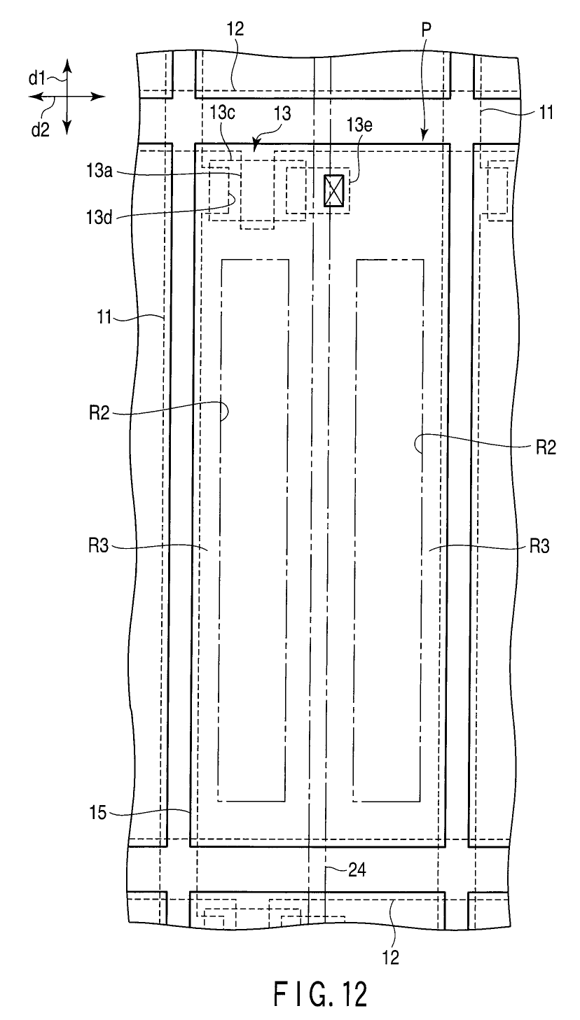

As shown in FIG. 12, according to the example 2, the first pretilt area R2 is positioned between the peripheral portion of the pixel electrode 15 and the projection 24 in each pixel P. The first pretilt area R2 is a strip area extending along the projection 24. The second pretilt area R3 is positioned outside the first pretilt area R2. The first PSA portions 18a and 28a are formed at the first pretilt area R2. The second PSA portions 18b and 28b are formed at the second pretilt area R3.

When light is first irradiated to the liquid crystal layer 3, light irradiation is carried out using a photo mask having the following pattern. Specifically, a plurality of strips of first pretilt areas R2 are exposed, and a plurality of second pretilt areas R3 are covered. The same liquid crystal display panel as the foregoing example 1 was completed except for the foregoing description.

Inventors of this application performed a characteristic evaluation of the liquid crystal display panel according to the example 2. As seen from FIG. 13, a white dot is visibly evaluated in a direction inclined to the front of the liquid crystal display panel, that is, from an oblique viewing angle direction; as a result, a white dot is not detected. Thus, a preferable oblique viewing angle is obtained. Therefore, a preferable image is displayable in an oblique direction in the liquid crystal display panel according to the example 2.

A speed (response speed of liquid crystal), that is, a change in speed from 0% to 10% of transmittance of the liquid crystal display panel is 20 ms. Thus, in low gradation side, preferable motion image display is possible. When voltages 0 V and 5 V are applied to the liquid crystal layer 3, a luminance of the liquid crystal display panel was measured, and further, a contrast ratio was calculated. As a result, the contrast ratio was 500.

### COMPARISON EXAMPLE 1

According to the comparison example 1, each pixel P has the first pretilt area R2 only, and does not have the second pretilt area R3. The first PSA portions 18a and 28a are formed at the first pretilt area R2. A first pretilt angle θ1 only is given to each pixel P. When light is irradiated to the liquid crystal layer 3, light irradiation is carried out using no photo mask. The same liquid crystal display panel as the foregoing example 1 was completed except for the foregoing description.

Inventors of this application performed a characteristic evaluation of the liquid crystal display panel according to the comparison example 1. As seen from FIG. 13, a white dot is visibly evaluated in a direction inclined to the front of the liquid crystal display panel, that is, from an oblique viewing angle direction; as a result, a white dot was detected. Thus, a preferable oblique viewing angle was not obtained. Therefore, a preferable image is not displayable in an oblique direction in the liquid crystal display panel according to the comparison example 1.

A speed (response speed of liquid crystal), that is, a change in speed from 0% to 10% of transmittance of the liquid crystal display panel is 20 ms. When voltages of 0 V and 5 V are applied to the liquid crystal layer 3, a luminance of the liquid crystal display panel was measured, and further, a contrast ratio was calculated. As a result, the contrast ratio was 500.

### COMPARISON EXAMPLE 2

According to the comparison example 2, a liquid crystal composition containing no polymer compound is injected between the array substrate 1 and the counter substrate 2 to form a liquid crystal layer 3. A liquid crystal display panel is formed without carrying out light irradiation with respect to the liquid crystal layer 3. The liquid crystal display panel has no PSA layers 18 and 28. The same liquid crystal display panel as the foregoing example 1 was completed except the foregoing description.

Inventors of this application performed a characteristic evaluation of the liquid crystal display panel according to the comparison example 2. As seen from FIG. 13, white dot is visibly evaluated in a direction inclined to the front of the liquid crystal display panel, that is, from an obliquely viewing angle direction; as a result, white dot was detected. Thus, a preferable obliquely viewing angle was not obtained. FIG. 14 is a graph showing a change in relative luminance L* with respect to each gradation of the front direction (0°), oblique direction (30°, 60°). As seen from FIG. 14, the liquid crystal display panel according to the comparison example 2 has luminance characteristic at equal intervals in 256 gradations in the front direction (0°). However, in the oblique direction (30°, 60°), the liquid crystal display panel has high luminance as a whole, and it can be seen that low gradation display is difficult.

A speed (response speed of liquid crystal), that is, a change in speed from 0% to 10% of transmittance of the liquid crystal display panel is 200 ms. When voltages of 0 V and 5 V are applied to the liquid crystal layer 3, luminance of the liquid crystal display panel was measured, and further, a contrast ratio was calculated. As a result, the contrast ratio was 500.

In the above-described the liquid crystal display panel and method of manufacturing the liquid crystal display panel, each pixel P has a plurality of pretilt angles different from each other. More specifically, in a state that a voltage is applied to the liquid crystal layer 3 formed of a liquid crystal composition containing a polymer compound, light is irradiated to the liquid crystal layer via a photo mask. In this way, the array substrate 1 is formed with a plurality of first PSA portions 18a while the counter substrate 2 is formed with a plurality of first PSA portions 28a. Thereafter, in a state that no voltage is applied to the liquid crystal layer 3, second-time light is irradiated to the liquid crystal layer 3 using no photo mask. In this way, the array substrate 1 is formed with a plurality of second PSA portions 18b while the counter substrate 2 is formed with a plurality of second PSA portions 28b.

Each pixel P has the first pretilt angle θ1 in the first pretilt area R2 and has the second pretilt angle θ2 in the second pretilt area R3. Thus, the liquid crystal molecule 3m of the first pretilt area R2 and the liquid crystal molecule 3m of the second pretilt area R3 are always inclined in a direction different from each other.

With the foregoing configuration, the following advantage is obtained. Specifically, it is possible to disperse a white dot generated in a specific direction inclined from the front of the conventional liquid crystal display panel. More specifically, it is possible to disperse the white dot in a plurality of oblique directions from the front of the liquid crystal display panel. In particular, the problem of the MVA mode having a number of reduced alignment divisions, that is, white dots can be improved. Thus, the liquid crystal display panel can display a preferable image in both front and oblique directions. This serves to obtain a liquid crystal display panel which is excellent in display quality over a wide viewing angle.

The first PSA portions 18a and 28a can give a low pretilt angle (θ1) to the first pretilt areas R2. In particular, in the example 2, the low pretilt angle (θ1) is given between the projection 24 and the peripheral edge of the pixel electrode 15 having late response conventionally. The liquid crystal display device has an excellent high-speed response; therefore, preferable motion image is displayed. The response speed is improved, and thereby, light transmittance is improved. Thus, it is possible to display a clear and bright image.

As described above, the PSA layers 18 and 28 are formed to improve the white dot. The technique is applicable to the case where the area of the pixel P is small in addition to the case where the area of the pixel P is large. This serves to prevent luminance reduction and high cost, and high reliability can be obtained.

From the foregoing description, it is possible to obtain a liquid crystal display panel which is excellent in display quality, and a method of manufacturing the same.

The invention is no limited to the foregoing embodiment, and constituent components are modified and embodied without departing from the subject matter in inventive step. A plurality of constituent components disclosed in the foregoing embodiments may be properly combined, and thereby, various inventions can be formed. For example, some constituent components may be deleted from all constituent components disclosed in the foregoing embodiment.

For example, the alignment controller may be formed of a plurality of lack portions formed in the common electrode 23. In this case, each lack portion overlaps with a plurality of pixels P, and is positioned so that the pixel P is divided into two equal portions in the second direction d2. The alignment controller is provided in the array substrate 1 to overlap with a plurality of pixels P, and may be formed of a plurality of projections projected to the side of the counter substrate 2. The alignment controller may be formed of at least one lack portion formed in each pixel electrode 15. The alignment controller may be formed of any one of the foregoing projection and the lack portion. The shape of the alignment controller is variously modified so long as the alignment controller controls an alignment state of liquid crystal molecules 3m.

When light is irradiated, light is irradiated from the outside of the array substrate 1, and not the outside of the counter substrate 2 having the color filter 4 preventing light from transmitting. Thus, when the liquid crystal display panel has a color filter on array (COA) structure, light may be irradiated from the outside of the counter substrate 2.

Each pixel P may have three or more pretilt angles different from each other. In this case, the voltage applied to the liquid crystal layer 3 and light irradiation area are changed, and then, light may be irradiated to the liquid crystal layer 3 more than three times.

The present invention is applicable to a twisted nematic (TN) mode liquid crystal display panel in addition to the MVA mode liquid crystal display panel. Thus, it is possible to obtain an effect of preventing gradation inversion in a TN mode.

According to the present invention, a plurality of pretilt angles is given to each pixel P. Thus, a plurality of pretilt angles may be given to each pixel P using means other than the PSA layers 18 and 28.

What is claimed is:

1. A liquid crystal display panel comprising:
a first substrate;
a second substrate arranged opposite to the first substrate with a gap;
a liquid crystal layer held between the first and second substrates; and
a plurality of pixels formed of the first substrate, the second substrate and the liquid crystal layer, and arrayed in a direction along a plane of the first and second substrates,
each pixel having a plurality of pretilt angles different from each other.

2. The liquid crystal display panel according to claim 1, wherein each pixel has a plurality of pretilt areas arranged in a direction along the plane,
the first substrate contacts with the liquid crystal layer, and has a liquid crystal molecule alignment maintaining layer overlapping with the pixels,
the second substrate contacts with the liquid crystal layer, and has another liquid crystal molecule alignment maintaining layer overlapping with the pixels, and
the liquid crystal molecule alignment maintaining layer and another liquid crystal molecule alignment maintaining layer give a pretilt angle different from each other to the pretilt areas of each pixel.

3. The liquid crystal display panel according to claim 1, further comprising:
an alignment controller provided in at least one of the first and second substrates, and controlling an alignment direction of a plurality of liquid crystal molecules of the liquid crystal layer.

4. The liquid crystal display panel according to claim 1, wherein the first substrate has a plurality of switching elements forming the pixels and a plurality of pixel electrodes connected to the switching elements,
the second substrate has a common electrode overlapping with the pixels and forming each pixel, and
the alignment controller is formed of a plurality of projections which provide in the second substrate to be overlapped with the pixels, and project to the side of the first substrate.

5. The liquid crystal display panel according to claim 1, wherein the first substrate has a plurality of switching elements forming the pixels and a plurality of pixel electrodes connected to the switching elements,
the second substrate has a common electrode overlapping with the pixels and forming each pixel, and
the alignment controller is formed of a plurality of lack portions formed in the common electrode.

6. The liquid crystal display panel according to claim 2, wherein the first substrate has a plurality of switching elements forming the pixels and a plurality of pixel electrodes connected to the switching elements,
the second substrate has a common electrode overlapping with the pixels and forming each pixel,
the alignment controller is formed of a plurality of projections which provide in the second substrate to be overlapped with the pixels, and project to the side of the first substrate, and
in each pixel, a pretilt area positioned between the peripheral edge of the pixel electrode and the projection has a pretilt angle smaller than other pretilt area.

7. The liquid crystal display panel according to claim 2, wherein the first substrate has a plurality of switching elements forming the pixels and a plurality of pixel electrodes connected to the switching elements,
the second substrate has a common electrode overlapping with the pixels and forming each pixel,
the alignment controller is formed of a plurality of lack portions formed in the common electrode, and
in each pixel, a pretilt area positioned between the peripheral edge of the pixel electrode and the lack portions has a pretilt angle smaller than other pretilt area.

8. A method of manufacturing a liquid crystal display panel, comprising:
preparing a liquid crystal panel including a first substrate, a second substrate arranged opposite to the first substrate with a gap, a liquid crystal layer held between the first and second substrates and formed of a liquid crystal composition containing a polymer compound and a plurality of pixels formed of the first substrate, the second substrate and the liquid crystal layer, and arrayed in a direction along a plane of the first and second substrates; and
irradiating light to the liquid crystal layer via a photo mask in a state that voltage is applied to the liquid crystal layer of the liquid crystal panel to harden the polymer compound, and giving a plurality of pretilt angles different from each other to each pixel.

9. The method of manufacturing a liquid crystal display panel according claim 8, wherein when light is irradiated to the liquid crystal layer, the hardened polymer compound forms a liquid crystal molecule alignment maintaining layer giving a pretilt angle at the first substrate, and forms another liquid crystal molecule alignment maintaining layer giving the pretilt angle at the second substrate.

10. The method of manufacturing a liquid crystal display panel according claim 8, wherein light is irradiated to the liquid crystal layer, and thereafter, light is irradiated to the liquid crystal layer in a state that no voltage is applied to the liquid crystal layer of the liquid crystal panel so that the polymer compound, which is not hardened is hardened.
